(19) United States
(12) Patent Application Publication
(10) Pub. No.: US 2023/0169423 A1
(43) Pub. Date: Jun. 1, 2023

(54) VEHICLE ALLOCATION SYSTEM

(71) Applicant: Toyota Jidosha Kabushiki Kaisha, Toyota-shi Aichi-ken (JP)

(72) Inventors: Kiyoto Sasaki, Susono-shi Shizuoka-ken (JP); Makoto Kawaharada, Susono-shi Shizuoka-ken (JP); Satoshi Nakamura, Susono-shi Shizuoka-ken (JP); Kenichi Okumura, Gotemba-shi Shizuoka-ken (JP); Naotoshi Kadotani, Susono-shi Shizuoka-ken (JP)

(73) Assignee: Toyota Jidosha Kabushiki Kaisha, Toyota-shi Aichi-ken (JP)

(21) Appl. No.: 17/963,522

(22) Filed: Oct. 11, 2022

(30) Foreign Application Priority Data
Nov. 29, 2021 (JP) 2021-193066

(51) Int. Cl. G06Q 10/06; G06Q 50/30

(52) U.S. Cl. CPC G06Q 10/06311; G06Q 50/30

(57) ABSTRACT

A vehicle allocation system includes a request reception unit that receives, from a classroom terminal device, vehicle allocation request information that is able to specify an end time of a classroom, the number of planned users who is scheduled to use a vehicle, and a desired alighting point, a route calculation unit that calculates, based on the specified number of planned users and the desired alighting point, and the number of vehicles that is able to be allocated at present, the number of vehicles to allocate and a route to the desired alighting point of each of the planned users, and a plan creation unit that creates a vehicle allocation plan based on the calculated number of vehicles to allocate and the calculated route such that the vehicles are allocated to the classroom as determined by the end time.

### CROSS-REFERENCE TO RELATED APPLICATION

This application claims priority to Japanese Patent Application No. 2021-193066 filed on Nov. 29, 2021, incorporated herein by reference in its entirety.

### BACKGROUND

### 1. Technical Field

The present disclosure relates to a technical field of a vehicle allocation system for allocating a vehicle for multiple returnees who are going to return home from a classroom where various activities outside of school or classes are performed and an end time is fixed.

### 2. Description of Related Art

As this type of device, for example, a vehicle allocation system that is used by multiple users living in a predetermined area and determines a vehicle allocation plan based on priority and reservation information based on user information has been proposed (see Japanese Unexamined Patent Application Publication No. 2020-187520 (JP 2020-187520 A)).

### SUMMARY

However, according to JP 2020-187520 A, in many cases, it is considered that return times overlap among multiple returnees such as students who return home from a classroom such as a cram school or an activity outside of school. Here, if an attempt is made to reserve a vehicle allocation service for each of the returnees such that vehicles are allocated all at once at the same time, there is a technical problem in a vehicle allocation system in which it becomes difficult or impossible to adjust vehicle allocation or to efficiently transfer a vehicle to each of the returnees.

The present disclosure has been made in view of, for example, the above technical problem, and an object of the present disclosure is to provide a vehicle allocation system that makes it possible to provide optimal or suitable vehicle allocation arrangements for returnees who return home from the classroom.

To solve the above issue, an aspect of a vehicle allocation system according to the present disclosure includes a request reception unit that receives, from a classroom terminal device provided in a classroom, vehicle allocation request information that is able to specify an end time of the classroom, the number of planned users who is scheduled to use a vehicle to return home from among students in the classroom, and a desired alighting point of each of the planned users,

a route calculation unit that calculates, based on the number of planned users and the desired alighting point specified from the vehicle allocation request information, and the number of vehicles that is able to be allocated at present, the number of vehicles to allocate to the classroom and a route to the desired alighting point of each of the planned users, and

a plan creation unit that creates a vehicle allocation plan based on the calculated number of vehicles to allocate and the calculated route such that the assigned number of vehicles corresponding to the vehicles to allocate are allocated to the classroom as determined by the end time.

With one aspect of the vehicle allocation system according to the present disclosure, for example, in a situation where return times overlap among multiple returnees from the classroom, it is possible to arrange allocation of the vehicles all at once in the classroom or in a classroom unit, and it is possible to provide optimal or suitable vehicle allocation arrangements according to the end time of the classroom and the multiple returnees from the classroom.

Such an action and effect according to the present disclosure will be further clarified by the embodiment of the disclosure described below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an example of an overall configuration of a vehicle allocation system according to the present disclosure;

FIG. 2 is a data structure diagram showing an example of data stored in a database in the vehicle allocation system according to the present disclosure;

FIG. 3 is a block diagram showing an example of a hardware configuration of a management server in the vehicle allocation system according to the present disclosure;

FIG. 4 is a block diagram showing an example of a hardware configuration of a classroom terminal device in the vehicle allocation system according to the present disclosure;

FIG. 5 is a flowchart showing an example of a process executed by the management server according to the present disclosure;

FIG. 6 is a data structure diagram showing an example of vehicle allocation request information according to the present disclosure;

FIG. 7 is a data structure diagram showing an example of a vehicle allocation plan according to the present disclosure; and

FIG. 8 is a data structure diagram showing an example of boarding time data according to the present disclosure.

### DETAILED DESCRIPTION OF EMBODIMENTS

1. Overall Configuration of Vehicle Allocation System

In the present disclosure, for example, a concept of a building unit as a place where a teacher (that is, an instructor, a coach, a teaching professional, a professor, etc.) of various classrooms, cram schools, schools, classes, lessons or activities outside of school, gyms, exercise facilities, training centers, etc. teach specific subjects to one or more persons who are taught is simply referred to as a “classroom” as appropriate. A time when the persons who are taught leave the classroom, such as an end time of the class, the lecture, the lecture attendance, the lesson, etc. or a time of returning home, is simply referred to as an “end time” as appropriate. Further, the persons who are taught such as multiple students, students going to a cram school, students attending lectures, auditors, participants, attendees, etc. who participate in or attend the classroom are simply referred to as a “student” as appropriate, the “student” who returns home from the “classroom” at the “end time” is referred to as a “returnee”, and the “returnee” or the “student” who is scheduled to use a vehicle to return home is referred to as a “planned user”.

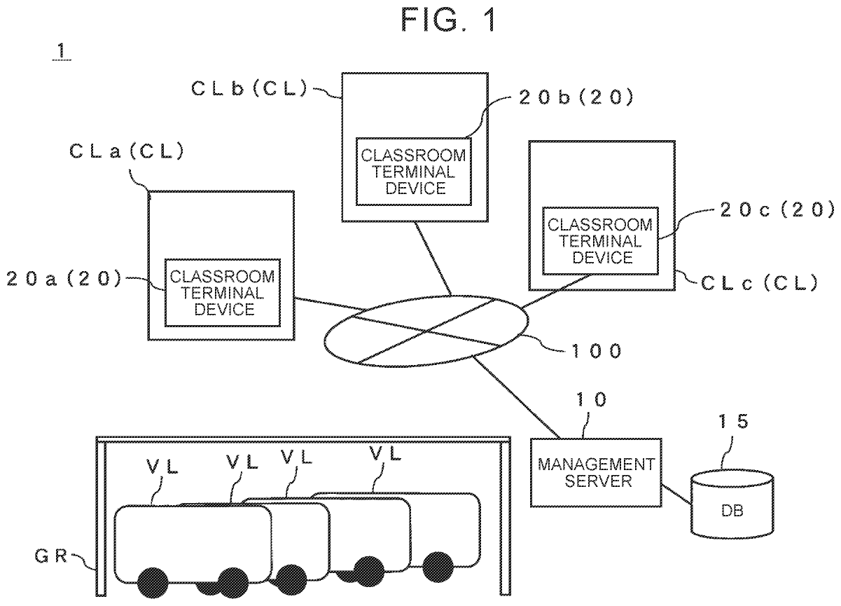

First, with reference to FIG. 1, an overall configuration of a vehicle allocation system 1 according to the present disclosure will be described. The vehicle allocation system 1 according to the present disclosure provides a vehicle allocation service for allocating vehicles that can be used by students returning home from the classroom.

As shown in FIG. 1, the vehicle allocation system 1 may include a management server 10 that can access a database 15 and classroom terminal devices 20a, 20b, and 20c provided in respective multiple classrooms CLa, CLb, and CLc. The management server 10 may be capable of data communication with the classroom terminal devices 20a, 20b, and 20c via a communication network, for example, the Internet 100. Each of the classrooms CLa, CLb, and CLc is the concept of the building unit as described above, and may be located in different places.

The classroom terminal device 20a is a terminal device that performs a process related to the classroom CLa, and may be provided in an office of the classroom CLa and operated by a related person of the classroom CLa, for example. The classroom terminal device 20b is a terminal device that performs a process related to the classroom CLb, and may be provided in an office of the classroom CLb and operated by a related person of the classroom CLb, for example. The classroom terminal device 20c is a terminal device that performs a process related to the classroom CLc, and may be provided in an office of the classroom CLc and operated by a related person of the classroom CLc, for example. Hereinafter, when it is not necessary to distinguish each classroom CLa, CLb, and CLc, the classroom is referred to as a classroom CL. Further, when it is not necessary to distinguish each classroom terminal device 20a, 20b, and 20c, the classroom terminal device is referred to as a classroom terminal device 20. Although the three classrooms CL are shown in FIG. 1, the number of classrooms CL provided with the classroom terminal devices 20 is not limited to three.

Under the management of an operating organization that operates the vehicle allocation service provided by the vehicle allocation system 1, for example, the management server 10 may be placed in a sales office of the organization or on the cloud. The management server 10 may be able to access the database 15 directly or via the Internet 100. The database 15 stores data necessary for a process executed by the management server 10. Note that, the management server 10 and the database 15 shown in FIG. 1 may have a conceptual configuration, and may be physically realized as one device or may be physically realized by multiple devices. For example, the database 15 may be provided in the management server 10. Further, the management server 10 may be realized by the classroom terminal device 20 as the classroom terminal device 20 takes charge of at least a part of the hardware configuration and the process of the management server 10.

Multiple vehicles VL in the vehicle allocation system 1 may be, for example, shared vehicles having multiple seats of the same number as each other or the same capacity as each other. These vehicles VL may be housed in, for example, a garage GR of the operating organization that operates the vehicle allocation service, and may be directly maintained and managed by the operating organization. The vehicle VL may be configured, for example, such that the students can review the content of the lesson taught in the classroom in a vehicle cabin. For example, the vehicle VL may be provided with a video reception unit capable of receiving a review video or the like distributed from each classroom CL and a monitor capable of playing a video in each seat. This allows the students to play the review video in their seats. The review video may be provided such that multiple past lessons including today's lesson can be selected, for example.

2. Data Stored in Database

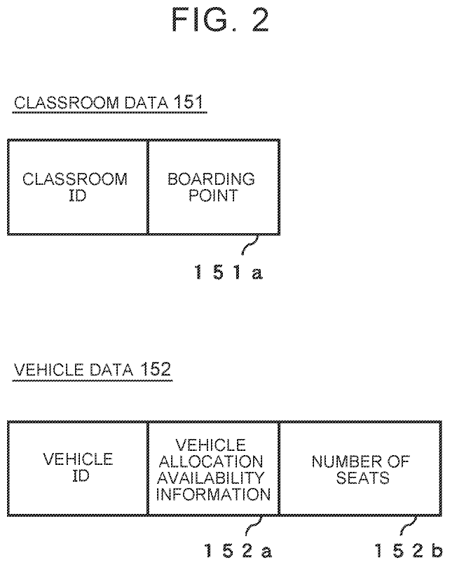

Next, with reference to FIG. 2, an example of data stored in the database 15 will be described. For example, the database 15 may store classroom data 151 and vehicle data 152. The classroom data 151 is data related to each classroom CL. In the classroom data 151, for example, a boarding point 151a may be associated with a classroom identification (ID) for identifying each classroom CL. The boarding point 151a indicates a point where the returnee from the classroom CL gets on the vehicle VL. A parking lot or a place where the vehicle can be stopped near the classroom CL, or a location of the classroom CL may be set to the boarding point 151a, for example. The classroom data 151 may be generated, for example, based on information provided by each classroom CL.

The vehicle data 152 is data related to each vehicle VL. In the vehicle data 152, for example, vehicle allocation availability information 152a and the number of seats 152b may be associated with a vehicle ID for identifying each vehicle VL. The vehicle allocation availability information 152a may indicate whether the corresponding vehicle VL can be allocated. A vehicle VL that cannot be allocated is, for example, a vehicle VL that has already been used for vehicle allocation or is scheduled to be used for vehicle allocation, or a vehicle VL for which maintenance and inspection are being performed. The number of seats 152b is the total number of seats for occupants provided in the vehicle VL. The total number of vehicles VL that can be allocated at present may be calculated based on the vehicle allocation availability information 152a as necessary, and the total number of vehicles VL may be retained as a data item of the vehicle data 152.

3. Hardware Configuration of Management Server

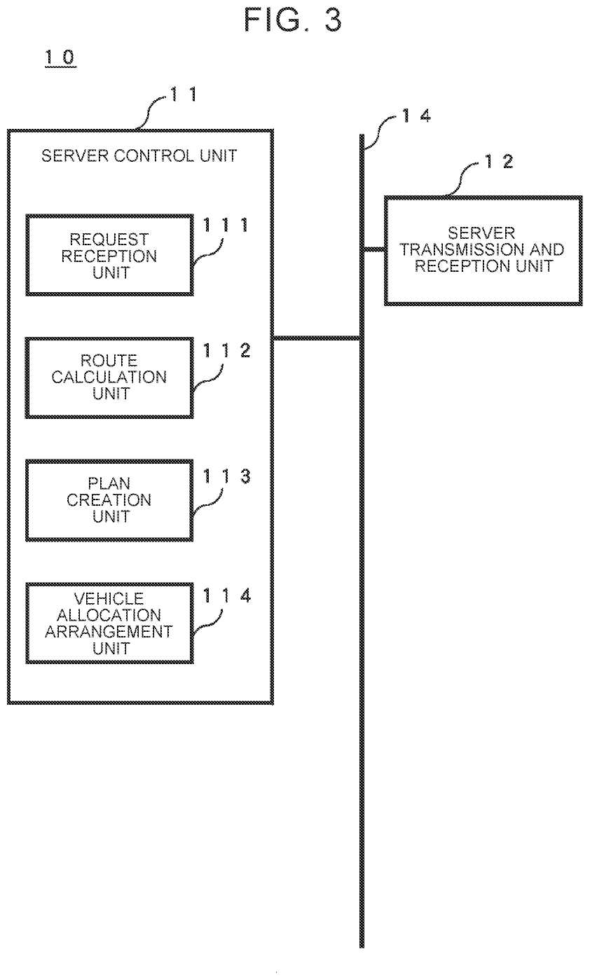

An example of the hardware configuration of the management server 10 will be described with reference to FIG. 3. Since the management server 10 is conceptual as described above, the hardware configuration and its operation shown in FIG. 3 may be realized by, for example, multiple server devices. Alternatively, at least a part of the hardware configuration and its operation may be realized by at least one classroom terminal device 20.

The management server 10 may include, for example, a server control unit 11 and a server transmission and reception unit 12. The server control unit 11 and the server transmission and reception unit 12 are capable of data communication with each other, and may be connected to each other via, for example, a data bus 14. Further, the management server 10 may include, for example, a data input-output unit (not shown) that accepts various operations of a system administrator of the vehicle allocation system 1 and outputs various data to the system administrator.

The server transmission and reception unit 12 may transmit and receive various data via the external configuration of the management server 10 (for example, the classroom terminal device 20 or the like) and, for example, the Internet 100. The server control unit 11 may be configured to control each process executed by the management server 10. The server control unit 11 may be configured as, for example, a computer unit composed of a central processing unit (CPU), and a random access memory (RAM) and a read-only memory (ROM) that are storage areas necessary for the operation of the CPU.

The server control unit 11 may read, for example, a computer program stored in the ROM and execute the program. Further, the server control unit 11 may read, for example, a computer program stored in a computer-readable non-volatile recording medium using a recording medium reading device (not shown). The server control unit 11 may read a computer program from a device (not shown) disposed outside the management server 10 via the Internet 100. The server control unit 11 executes the read computer program. As a result, a logical functional block for executing the operation to be performed by the management server 10 is realized in the server control unit 11. That is, the server control unit 11 can function as a controller for realizing a logical functional block for executing the operation to be performed by the management server 10. FIG. 3 shows an example of the logical functional block realized in the server control unit 11. As shown in FIG. 3, in the server control unit 11, for example, a request reception unit 111, a route calculation unit 112, a plan creation unit 113, and a vehicle allocation arrangement unit 114 may be realized.

4. Operation of Server Control Unit

The operation of each unit 111 to 114 realized by the server control unit 11 will be described. The transmission and reception of data in respective units 111 to 114 include transmission and reception via the server transmission and reception unit 12.

The request reception unit 111 may receive vehicle allocation request information that is a vehicle allocation request from each classroom CL. The vehicle allocation request information is information for requesting vehicle allocation for a planned user of the vehicle VL to return home, and is transmitted from the classroom terminal device 20 provided in the classroom CL. The vehicle allocation request information transmitted from the classroom CL may be, for example, information that in which the end time of the classroom CL, the number of planned users, a desired alighting point where each planned user desires to alight from the vehicle, and the like can be specified by the server control unit 11. When multiple classes having the same end time are provided in one classroom CL, the “end time of the classroom CL” may be the end time corresponding to the multiple classes. Details of the vehicle allocation request information will be described below.

The route calculation unit 112 may calculate, for example, based on the vehicle allocation request information received by the request reception unit 111 and the number of vehicles VL that can be allocated at present, the number of vehicles VL to allocate to the multiple classrooms CL having the same end time and boarding point 151a as each other and a route from the boarding point 151a to each desired alighting point regarding each vehicle to allocate. A method of calculating the route will be described below.

The plan creation unit 113 may create, for example, a vehicle allocation plan based on the calculated number of vehicles to allocate and the calculated route such that the assigned number of vehicles VL corresponding to the vehicles to allocate are allocated to the boarding point 151a as determine by the end time. Details of the vehicle allocation plan will be described below. The plan creation unit 113 may transmit the created vehicle allocation plan to the classroom terminal device 20 of the classroom CL that has requested the vehicle allocation.

The vehicle allocation arrangement unit 114 may arrange the allocation of the vehicle VL according to each created vehicle allocation plan, for example. Specifically, for example, when the operating organization that operates the vehicle allocation service has a vehicle management department that maintains and manages the vehicle VL, the vehicle allocation arrangement unit 114 may request the vehicle management department to allocate the vehicle according to the vehicle allocation plan. Details of the vehicle allocation arrangement will be described below.

5. Hardware Configuration of Classroom Terminal Device

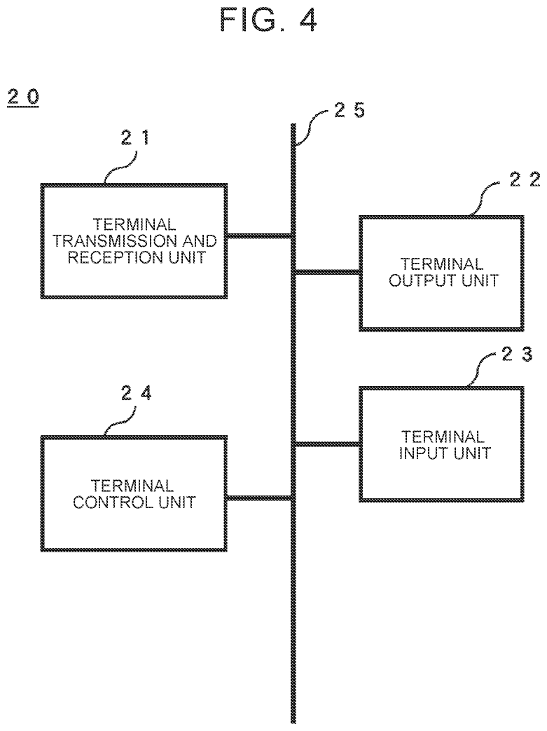

An example of the hardware configuration of the classroom terminal device 20 provided in the classroom CL will be described with reference to FIG. 4. The classroom terminal device 20 may include, for example, a terminal transmission and reception unit 21, a terminal output unit 22, a terminal input unit 23, and a terminal control unit 24. The terminal transmission and reception unit 21, the terminal output unit 22, the terminal input unit 23, and the terminal control unit 24 may be connected to each other via, for example, a data bus 25 so as to be capable of data communication with each other. The terminal transmission and reception unit 21 may be configured to perform transmission and reception of various data to and from the external configuration of the classroom terminal device 20 such as the management server 10 via the Internet 100, for example. The terminal output unit 22 may be configured to output various data to, for example, a related person such as a clerk of the classroom CL. The data output includes screen output, voice output, and the like. The terminal input unit 23 may be configured to receive data input of various data by, for example, a related person such as a clerk of the classroom CL. The data input includes, for example, input via various input devices such as a keyboard and a mouse, contact input to a touch panel, buttons, and the like, non-contact input, and voice input.

The terminal control unit 24 may be configured to control each process in the classroom terminal device 20 by controlling the operations of the other units 21, 22, and 23. The terminal control unit 24 may be configured as, for example, a computer unit composed of a CPU, and a RAM and a ROM that are storage areas necessary for the operation of the CPU. For example, the classroom ID of the corresponding classroom CL may be stored in the ROM. The terminal control unit 24 may, for example, cause the user to input data in accordance with a command from the management server 10 and transmit the input data to the management server 10. Further, for example, the terminal control unit 24 may acquire data from the management server 10 and output the acquired data to the user in accordance with a command from the management server 10. The terminal control unit 24 may be configured to realize at least a part of each of the above-mentioned units 111 to 114 of the server control unit 11.

6. Process Performed in Vehicle Allocation System

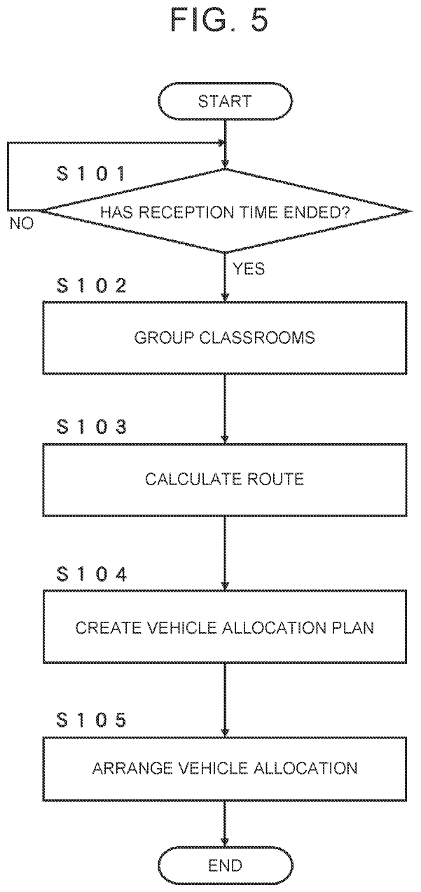

With reference to FIGS. 5 to 7, a vehicle allocation service process performed for the vehicle allocation service to be provided in the vehicle allocation system 1 will be described focusing on a process performed by the server control unit 11. The server control unit 11 may appropriately refer to the classroom data 151 and the vehicle data 152 of the database 15 as necessary.

The request reception unit 111 of the server control unit 11 may be in a waiting state for receiving the vehicle allocation request information (that is, waiting for reception) within a predetermined reception time before the end time of the classroom CL (step S101). The related person such as the clerk of the classroom CL confirms the use of the vehicle VL, the desired alighting point, and the like with each student in the classroom CL such that the vehicle allocation request information is received within the reception time, for example, and the vehicle allocation request information may be generated based on the confirmed information and transmitted from the classroom terminal device 20.

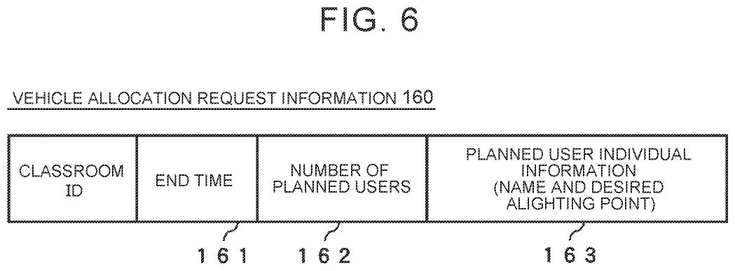

FIG. 6 shows vehicle allocation request information 160 that is an example of the vehicle allocation request information. As shown in FIG. 6, the vehicle allocation request information 160 may include, for example, a classroom ID, an end time 161, the number of planned users 162, and planned user individual information 163. As described above, the end time 161 may be an end time at which the classes or the like in the classroom CL end, that is, a time when the students in the classroom CL return home all at once. The number of planned users 162 may be the number of planned users who is scheduled to use the vehicle VL to return home. The planned user individual information 163 is information on each planned user constituting the number of users indicating the number of planned users 162, and may include, for example, the name of the planned user and the desired alighting point where the planned user desires to alight from the vehicle (for example, home address). The number of planned users 162 may not be included in the vehicle allocation request information 160 transmitted from the classroom CL. In this case, for example, the request reception unit 111 that has received the vehicle allocation request information 160 may specify the total value of the number of planned users included in the planned user individual information 163 as the number of planned users 162.

Returning to FIG. 5, for example, when the reception time ends (step S101: Yes), the request reception unit 111 may group the classrooms CL corresponding to the multiple pieces of received vehicle allocation request information 160 (step S102). For example, classrooms CL having the same end time 161 and boarding point 151a may be set as one group. As a result, it is possible to provide a vehicle allocation service in a group unit in which multiple classrooms CL having the same end time 161 and boarding point 151a are grouped. Therefore, the following processes (steps S103 to S105) may be performed for each group.

The route calculation unit 112 of the server control unit 11 may perform a route calculation process for the multiple classrooms CL in the group (step S103). As the route calculation process, the route calculation unit 112 may calculate, based on the number of planned users 162, the desired alighting point of each planed user, and the number of vehicles VL that can be allocated at present, the number of vehicles VL to allocate to the multiple classrooms CL and a route from the boarding point 151a to each desired alighting point regarding each vehicle VL. The route may be calculated, for example, by a predetermined algorithm. The number of vehicles VL that can be allocated may be obtained, for example, by summing up the number of vehicles VL indicated by the vehicle allocation availability information 152a that the vehicles can be allocated. The number of vehicles to allocate may be obtained, for example, by calculating the total number of seats from the number of vehicles to allocate and the number of seats 152b, and obtained from the relationship with the total number of planned users 162 of the vehicle allocation request information 160. For example, the route calculation unit 112 may group the planned users of the same classroom CL as one classroom group, and calculate the route such that the same vehicle VL is assigned to the planned users of the same classroom group. Alternatively, the route calculation unit 112 may group, for example, the planned users for which the desired alighting point is close as one alighting group, and calculate the route such that the same vehicle VL is assigned to the planned users of the same alighting group.

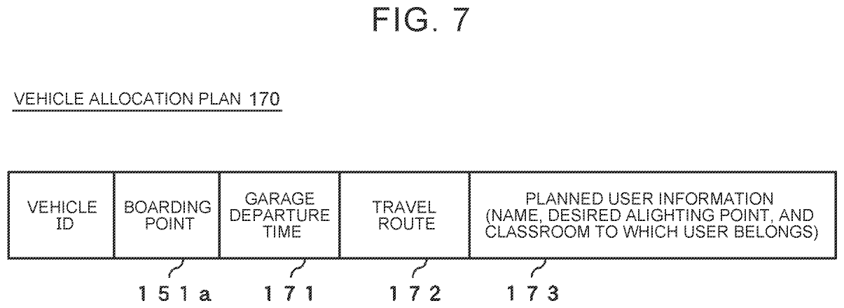

Subsequently, the plan creation unit 113 of the server control unit 11 may perform a vehicle allocation plan creation process (step S104). As a vehicle allocation plan creation process, the plan creation unit 113 may assign the planned user and the vehicle VL to each route based on the calculated number of vehicles to allocate and the calculated route, and create a vehicle allocation plan. FIG. 7 shows a vehicle allocation plan 170 that is an example of the vehicle allocation plan. As shown in FIG. 7, the vehicle allocation plan 170 may be created based on the vehicle VL. In the vehicle allocation plan 170, for example, the boarding point 151a, a garage departure time 171, a travel route 172, and planned user information 173 may be associated with the vehicle ID. The boarding point 151a may be the boarding point 151a of the classroom CL to which the vehicle VL is allocated. The garage departure time 171 is a departure time of the vehicle VL from the garage GR where the vehicle VL is waiting, and may be, for example, a time calculated back such that the vehicle VL arrives at the boarding point 151a of the classroom CL in accordance with the end time 161 of the classroom CL. The travel route 172 may indicate a route assigned to the vehicle VL (that is, a route along which the vehicle VL travels). The planned user information 173 may include, for example, the name of the planned user who is assigned to the vehicle VL, that is, the planned user who plans to board the vehicle VL, the desired alighting point, and the classroom to which the user belongs. The planned user information 173 may be generated based on, for example, the classroom ID and the planned user individual information 163 included in the vehicle allocation request information 160. The plan creation unit 113 may transmit, for example, the created vehicle allocation plan 170 to the classroom terminal device 20 that has transmitted the vehicle allocation request information 160. As a result, the classroom CL can confirm the correspondence between the planned user and the vehicle VL to be allocated.

Returning to FIG. 5, the vehicle allocation arrangement unit 114 of the server control unit 11 may perform a vehicle allocation arrangement process when the vehicle allocation plan 170 is created (step S105). For example, when the operating organization that operates the vehicle allocation service has a vehicle management department that maintains and manages the vehicle VL that can be allocated, the vehicle allocation arrangement unit 114 may transmit, for example, the created vehicle allocation plan (or the completion notification notifying that the vehicle allocation plan has been created) to the server (not shown) of the vehicle management department. In the vehicle management department that has received the completion notification, for example, the vehicle allocation plan 170 stored in the storage area of the server control unit 11 may be viewed from a terminal device (not shown) provided in the vehicle management department. For example, after the vehicle allocation arrangement process, the vehicle allocation arrangement unit 114 may set the vehicle allocation availability information 152a (see FIG. 2) of each vehicle VL corresponding to the vehicle allocation plan 170 to a state in which “the vehicle cannot be allocated”.

As a result, a series of processes related to the vehicle allocation service process in the vehicle allocation system 1 is completed.

When there is only one piece of vehicle allocation request information 160 received within the reception time, the request reception unit 111 may not group the classrooms CL (step S102). Further, when there is one piece of vehicle allocation request information 160 received within the reception time, or when there is one classroom CL in the group, steps S103 to S104 may be performed for the one classroom CL.

The classroom data 151 stored in the database 15 may include student information as information on each student. The student information may include, for example, information associated with a student ID for identifying each student, and a name and a desired alighting point of each student. In this case, for example, a student ID corresponding to each planned user may be set in the planned user individual information 163 of the vehicle allocation request information 160 transmitted from the classroom terminal device 20. The request reception unit 111 that has received the vehicle allocation request information 160 may refer to the student information of the corresponding classroom data 151 based on each student ID set in the planned user individual information 163, for example, and specify the name and the desired alighting point of each planned user. The request reception unit 111 may set the name and the desired alighting point of each specified planned user in the corresponding planned user individual information 163 of the vehicle allocation request information 160.

Further, for example, when the end time of the classroom CL is fixed, the end time may be included in the classroom data 151 stored in the database 15. In this case, the vehicle allocation request information 160 transmitted from the classroom terminal device 20 may not include the end time 161. The request reception unit 111 that has received the vehicle allocation request information 160 may refer to the corresponding classroom data 151 based on the classroom ID, for example, and specify the end time. The request reception unit 111 may set the specified end time to the end time 161 of the corresponding vehicle allocation request information 160.

The vehicle allocation system 1 may be configured to provide an independent vehicle allocation service for each classroom CL. In this case, in the process of FIG. 5, steps S101 and S102 are unnecessary, and with reception of the vehicle allocation request information 160 from the classroom CL as a trigger, the server control unit 11 may perform steps S103 to S105 for the classroom CL corresponding to the vehicle allocation request information 160 for each received vehicle allocation request information 160.

For example, when the vehicle VL that can be allocated is maintained and managed by an organization different from the operating organization, the vehicle allocation arrangement unit 114 may transmit, for example, the vehicle allocation plan to a server (not shown) of the different organization to arrange the vehicle allocation.

When the number of seats for occupants differs depending on the vehicle VL, the route calculation unit 112 may assign, for example, a vehicle VL having a larger number of seats to a desired alighting point of the planned user. Alternatively, for example, an algorithm for route calculation may be set such that a vehicle VL having the appropriate number of seats is assigned to each alighting group according to the number of planned users included in the alighting group.

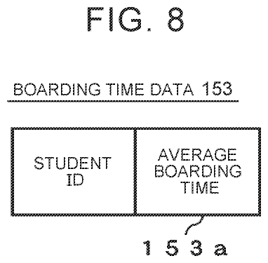

Further, in the vehicle allocation system 1, the vehicle allocation plan 170 may be created such that the difference in boarding times between the planned users is reduced. In this case, for example, as shown in FIG. 8, the database 15 may store the boarding time data 153 in which the average boarding time 153a for which a student using the vehicle VL has boarded the vehicle VL is associated with the student who has used the vehicle VL (for example, a student ID for identifying each student may be used). For example, the plan creation unit 113 may modify the calculated route such that planned users whose average boarding time 153a is longer than the other planned users among the planned users assigned to the route calculated by the route calculation unit 112 are transferred to the desired alighting point ahead of the other planned users. The plan creation unit 113 may set the modified route as the travel route 172 of the vehicle allocation plan 170. For example, the plan creation unit 113 may calculate the scheduled boarding time of each student in the travel route 172 of the created vehicle allocation plan 170, and update the average boarding time 153a of the boarding time data 153.

As described in detail above, according to the vehicle allocation system 1, in a situation where the return times overlap among the multiple returnees to return home from the classroom, it is possible to arrange the vehicle allocation either in the classroom or in the classroom unit all at once. Based on the information obtained from the classroom, it is possible to provide an optimal or suitable vehicle allocation service according to the end time of the classroom and the multiple returnees from the classroom.

Appendices

The following appendices will be further disclosed with respect to the embodiment described above.

[Appendix 1]

The vehicle allocation system described in Appendix 1 according to the present disclosure includes a request reception unit that receives, from a classroom terminal device provided in a classroom, vehicle allocation request information that is able to specify an end time of the classroom, the number of planned users who is scheduled to use a vehicle to return home from among students in the classroom, and a desired alighting point of each of the planned users, a route calculation unit that calculates, based on the number of planned users and the desired alighting point specified from the vehicle allocation request information, and the number of vehicles that is able to be allocated at present, the number of vehicles to allocate to the classroom and a route to the desired alighting point of each of the planned users, and a plan creation unit that creates a vehicle allocation plan based on the calculated number of vehicles to allocate and the calculated route such that the assigned number of vehicles corresponding to the vehicles to allocate are allocated to the classroom as determined by the end time.

According to the vehicle allocation system described in Appendix 1, prior to the end of the classroom, the vehicle allocation request information that is able to specify the end time of the classroom, the number of planned users in the classroom, and the desired alighting point of each of the planned users is transmitted from the classroom terminal device provided in the classroom. This vehicle allocation request information is received, for example, by the request reception unit of the vehicle allocation system via a network. Subsequently, in the vehicle allocation system, the route calculation unit calculates, based on the number of planned users and the desired alighting point specified from the vehicle allocation request information, and the number of vehicles that is able to be allocated at present, the number of vehicles to allocate to the classroom and the route to the desired alighting point of each of the planned users. Further, in the vehicle allocation system, the plan creation unit creates the vehicle allocation plan as determined by the end time based on the calculated number of vehicles to allocate and the calculated route. When the vehicles are actually allocated to the classroom according to the vehicle allocation plan created as described above, in a situation where return times overlap among multiple returnees from the classroom, each of the planned users does not need to arrange allocation of the vehicles, and it is possible to provide vehicle allocation arrangements in the classroom or in the classroom unit all at once. Based on the information obtained from the classroom, it is possible to provide an optimal or suitable vehicle allocation arrangement according to the end time of the classroom and multiple students in the classroom.

[Appendix 2]

The vehicle allocation system described in Appendix 2 according to the present disclosure is the vehicle allocation system described in Appendix 1 further including a vehicle allocation arrangement unit that arranges allocation of the assigned number of vehicles corresponding to the vehicles to allocate according to the vehicle allocation plan created by the plan creation unit.

According to the vehicle allocation system described in Appendix 2, when the vehicle allocation plan is created by the plan creation unit, the allocation of the vehicles is arranged by the vehicle allocation arrangement unit according to the vehicle allocation plan.

[Appendix 3]

The vehicle allocation system described in Appendix 3 according to the present disclosure is the vehicle allocation system described in Appendix 1 in which the request reception unit receives the vehicle allocation request information for multiple classrooms each corresponding to the classroom, the route calculation unit calculates the number of vehicles to allocate and the route for the multiple classrooms, and the plan creation unit creates the vehicle allocation plan for each of the assigned number of vehicles corresponding to the vehicles to allocate.

According to the vehicle allocation system described in Appendix 3, vehicle allocation efficiency is not improved by adjustments of the vehicle allocation only in a single classroom, but the vehicle allocation efficiency is improved by adjustments of the multiple classrooms. Therefore, it is possible to realize a more efficient vehicle allocation service for the multiple classrooms.

[Appendix 4]

The vehicle allocation system described in Appendix 4 according to the present disclosure is the vehicle allocation system described in any one of Appendices 1 to 3 in which the plan creation unit creates the vehicle allocation plan such that a difference in boarding times between the planned users who get on the vehicles is small.

According to the vehicle allocation system described in Appendix 4, the difference in the boarding times between the planned users is small, so that the planned users can get a sense of fairness as a whole.

[Appendix 5]

The vehicle allocation system described in Appendix 5 according to the present disclosure is the vehicle allocation system described in any one of Appendices 1 to 4 in which the vehicle is characterized by being configured such that a lesson taught in the classroom is able to be reviewed in a vehicle cabin.

According to the vehicle allocation system described in Appendix 5, students or parents, etc. of the students can review the lesson taught in the classroom using the service provided by the vehicle allocation system while the vehicle is moving. Therefore, it is very convenient in practice because the traveling time for returning home can be effectively utilized and the effect of the classroom can be efficiently improved by reviewing immediately after the classroom.

The present disclosure can be appropriately modified to the extent that the modification does not contradict the gist or idea of the disclosure that can be read from the claims and the entire specification, and the vehicle allocation system accompanied by such modification is also included in the technical idea of the present disclosure. The present disclosure can be applied to an autonomous driving vehicle.

What is claimed is:

1. A vehicle allocation system comprising:
a request reception unit that receives, from a classroom terminal device provided in a classroom, vehicle allocation request information that is able to specify an end time of the classroom, a number of planned users who is scheduled to use a vehicle to return home from among students in the classroom, and a desired alighting point of each of the planned users;
a route calculation unit that calculates, based on the number of planned users and the desired alighting point specified from the vehicle allocation request information, and a number of vehicles that is able to allocate at present, the number of vehicles to allocate to the classroom and a route to the desired alighting point of each of the planned users; and
a plan creation unit that creates a vehicle allocation plan based on the calculated number of vehicles to allocate and the calculated route such that an assigned number of vehicles corresponding to the vehicles to allocate are allocated to the classroom as determined by the end time.

2. The vehicle allocation system according to claim 1, further comprising a vehicle allocation arrangement unit that arranges allocation of the assigned number of vehicles corresponding to the vehicles to allocate according to the vehicle allocation plan created by the plan creation unit.

3. The vehicle allocation system according to claim 1, wherein the request reception unit receives the vehicle allocation request information for multiple classrooms each corresponding to the classroom, the route calculation unit calculates the number of vehicles to allocate and the route for the multiple classrooms, and the plan creation unit creates the vehicle allocation plan for each of the assigned number of vehicles corresponding to the vehicles to allocate.

4. The vehicle allocation system according to claim 1, wherein the plan creation unit creates the vehicle allocation plan such that a difference in boarding times between the planned users who get on the vehicles is small.

5. The vehicle allocation system according to claim 1, wherein the vehicle is configured such that a lesson taught in the classroom is able to be reviewed in a vehicle cabin.
